(19) United States
(12) Patent Application Publication
(10) Pub. No.: US 2026/0356375 A1
(43) Pub. Date: Nov. 12, 2026

(54) VEHICLE AND METHOD FOR CONTROLLING SAME

(71) Applicants: HYUNDAI MOTOR COMPANY, Seoul (KR); KIA CORPORATION, Seoul (KR)

(72) Inventors: Su Jin HAN, Hwaseong-si (KR); Hong Gyu LEE, Hwaseong-si (KR)

(21) Appl. No.: 19/634,666

(22) Filed: Mar. 31, 2026

(30) Foreign Application Priority Data
May 7, 2025 (KR) 10-2025-0059170

(51) Int. Cl. B60W 50/00; B60W 60/00

(52) U.S. Cl. CPC B60W 50/0098; B60W 60/001; B60W 2510/20; B60W 2520/06; B60W 2520/10; B60W 2756/10

(57) ABSTRACT

An autonomous vehicle control device may include: a memory storing at least one instruction; and one or more processors connected to the memory, wherein the instruction is configured, when executed by the one or more processors, to cause the autonomous vehicle control device to: calculate a change value of a steering control amount by comparing a travel path of a vehicle at a first time point with a travel path of the vehicle at a second time point after the first time point; when the change value is greater than or equal to a preset value, set any position in the travel path at the first time point as a start point; set any position of the travel path at a second time point as an end point; and generate a convergence path based on the start point and the end point.

### CROSS-REFERENCE TO RELATED APPLICATION

This application claims the benefit of priority to Korean Patent Application No. 10-2025-0059170, filed in the Korean Intellectual Property Office on May 7, 2025, the disclosure of which is incorporated herein by reference in its entirety.

### TECHNICAL FIELD

Various examples of the present disclosure relate to an autonomous vehicle and a method of controlling an autonomous vehicle.

### BACKGROUND

The matters described in this Background section are only for enhancement of understanding of the background of the disclosure, and should not be taken as acknowledgment that they correspond to prior art already known to those skilled in the art.

In an autonomous driving system, a sudden change in a steering control amount may occur according to a situation such as lane change cancellation and map information switching. Such a sudden change in the steering control amount may impair the behavioral stability of a vehicle, cause an unpleasant riding experience for the occupant, and further adversely affect the collision avoidance performance or the lane keeping control.

### SUMMARY

The technical object to be achieved by the present disclosure has been devised in order to solve the above-described problems, and an object of the present disclosure is to set a plurality of path points in a situation in which a steering control amount suddenly changes and generate a convergence path based on the plurality of path points, so as to naturally change the behavior of a vehicle.

The problems to be solved by the present disclosure are not limited to the above-mentioned problems, and other problems that are not mentioned will be clearly understood by a person skilled in the art from the following description.

According to the present disclosure, an apparatus of a vehicle may comprise a processor and a memory storing at least one instruction that, when executed by the processor, is configured to cause the apparatus to determine a change value of a steering control amount associated with the vehicle by comparing a first travel path of the vehicle at a first time point with a second travel path of the vehicle at a second time point after the first time point, and, based on the change value being greater than or equal to a preset value, set a first position in the first travel path at the first time point as a start point, set a second position in the second travel path at the second time point as an end point, generate, based on the start point and the end point, a convergence path, output a signal indicating the convergence path, and control, based on the signal, autonomous driving of the vehicle. The apparatus may further be configured, via the at least one instruction when executed by the processor, to output the convergence path through an interface of the vehicle and to transmit the convergence path to another vehicle through a communication interface of the vehicle. In the apparatus, the start point may be set to one of a position at which a control target point of the vehicle at the first time point is positioned or a position on a reference line that is set based on a traveling direction of the vehicle at the first time point. The apparatus may further be configured, via the at least one instruction when executed by the processor, to determine, based on a speed of the vehicle at the second time point and a regulatory allowable first lateral acceleration, a lower limit value of a longitudinal distance and an upper limit value of the longitudinal distance, wherein the longitudinal distance corresponds to a forward distance along a traveling direction of the vehicle, and to set the end point to a position between the lower limit value and the upper limit value. The apparatus may further be configured, via the at least one instruction when executed by the processor, to determine, based on the speed of the vehicle and the regulatory allowable first lateral acceleration, a minimum feasible radius of curvature of a travel path of the vehicle, and to set a longitudinal distance corresponding to the minimum feasible radius of curvature as a lower limit of the end point. The apparatus may further be configured, via the at least one instruction when executed by the processor, to determine, based on the speed of the vehicle and a second lateral acceleration that is smaller than the regulatory allowable first lateral acceleration, a maximum feasible radius of curvature of a travel path of the vehicle, and to set a longitudinal distance corresponding to the maximum feasible radius of curvature to an upper limit value of the end point. The apparatus may further be configured, via the at least one instruction when executed by the processor, to select, based on a surrounding environment of the vehicle, the end point as a point between the lower limit value and the upper limit value. In the apparatus, the surrounding environment of the vehicle may comprise at least one of whether another vehicle is positioned in an adjacent lane of the vehicle or whether another vehicle positioned in front of the vehicle in a traveling lane stops or decelerates. The apparatus may further be configured, via the at least one instruction when executed by the processor, to set a position between the start point and the end point to an intermediate point, to set a first sub-point between the start point and the intermediate point, to set a second sub-point between the intermediate point and the end point, and to generate the convergence path based on the start point, the first sub-point, the intermediate point, the second sub-point, and the end point. The apparatus may further be configured, via the at least one instruction when executed by the processor, to adjust a position of the first sub-point and a position of the second sub-point based on a gain value determined based on a speed of the vehicle, a distance between the start point and the end point, and a curvature difference between a lane on which the vehicle is traveling and a target lane. According to the present disclosure, a method performed by an apparatus of a vehicle may comprise determining a change value of a steering control amount associated with the vehicle by comparing a first travel path of the vehicle at a first time point with a second travel path of the vehicle at a second time point after the first time point, and, based on the change value being greater than or equal to a preset value, setting a first position in the first travel path at the first time point as a start point, setting a second position in the second travel path at the second time point as an end point, generating, based on the start point and the end point, a convergence path, outputting a signal indicating the convergence path, and controlling, based on the signal, autonomous driving of the vehicle. The method may further comprise outputting the convergence path through an interface of the vehicle and transmitting the convergence path to another vehicle through a communication interface of the vehicle. In the method, the start point may be set to one of a position at which a control target point of the vehicle at the first time point is located or a point on a reference line that is set based on a traveling direction of the vehicle at the first time point. The method may further comprise determining, based on a speed of the vehicle and a regulatory allowable first lateral acceleration, a lower limit value of a longitudinal distance and an upper limit value of the longitudinal distance, wherein the longitudinal distance corresponds to a forward distance along a traveling direction of the vehicle, and setting the end point to a position between the lower limit value and the upper limit value. The method may further comprise determining, based on the speed of the vehicle and the regulatory allowable first lateral acceleration, a minimum feasible radius of curvature of a travel path of the vehicle, and setting a longitudinal distance corresponding to the minimum feasible radius of curvature as a lower limit value of the end point. The method may further comprise determining, based on the speed of the vehicle and a second lateral acceleration that is smaller than the regulatory allowable first lateral acceleration, a maximum feasible radius of curvature of a travel path of the vehicle, and setting a longitudinal distance corresponding to the maximum feasible radius of curvature as an upper limit value of the end point. In the method, setting the end point may comprise selecting, based on a surrounding environment of the vehicle, one of positions between the lower limit value and the upper limit value to be the end point. According to the present disclosure, a vehicle may comprise a sensor configured to obtain travel-path information associated with the vehicle and a processor circuit configured to cause the vehicle to obtain, via the sensor, first travel-path information at a first time and second travel-path information at a second time, and, based on a difference between the first travel-path information and the second travel-path information exceeding a threshold value, set a start point at a position indicated in the first travel-path information, set an end point at a position indicated in the second travel-path information, wherein the end point is set between a lower limit value of a longitudinal distance and an upper limit value of the longitudinal distance based on a speed of the vehicle and a lateral acceleration limit of the vehicle and wherein the longitudinal distance corresponds to a forward distance along a traveling direction of the vehicle, generate, based on the start point and the end point, a convergence path configured to connect a first trajectory represented by the first travel-path information to a second trajectory represented by the second travel-path information, output a signal indicating the convergence path, and control, based on the signal, autonomous driving of the vehicle. In the vehicle, the processor circuit may further be configured to set a position between the start point and the end point as an intermediate point, to set a first sub-point between the start point and the intermediate point, to set a second sub-point between the intermediate point and the end point, and to generate the convergence path based on the start point, the first sub-point, the intermediate point, the second sub-point, and the end point. In the vehicle, the processor circuit may further be configured to adjust positions of the first sub-point and the second sub-point based on a gain value determined based on the speed of the vehicle, a distance between the start point and the end point, and a curvature difference between a lane on which the vehicle is traveling and a target lane.

The effects of the present disclosure are not limited to the above-mentioned effects, and other effects that are not mentioned will be clearly understood by a person skilled in the art from the following description.

### BRIEF DESCRIPTION OF THE DRAWINGS

FIG. 1 shows an example of an autonomous vehicle.

FIG. 2 shows an example of generating a convergence path and performing driving control in a situation in which a steering control amount suddenly changes.

FIG. 3 shows an example of a point setting process for generating a convergence path.

FIG. 4 shows an example of setting a convergence path through a reference line and point placement.

FIGS. 5, 6 , and 7. show examples of setting an end point according to a surrounding vehicle situation.

FIG. 8 shows an example of a detailed procedure for generating a convergence path.

FIG. 9 shows an example of a process of applying a sub-point to a convergence path.

FIGS. 10-13 show exemplary diagrams for adjusting a position of a sub-point.

FIG. 14 shows an example computing system.

### DETAILED DESCRIPTION

Hereinafter, preferred examples of the present disclosure will be described in detail with reference to the accompanying drawings.

However, the technical spirit of the present disclosure is not limited to some examples to be described but may be implemented in various different forms, and one or more of the constituent elements between the examples may be selectively combined and substituted within the scope of the technical spirit of the present disclosure.

In addition, terms (including technical and scientific terms) used in the examples of the present disclosure may be interpreted as meanings that can be generally understood by those of ordinary skill in the art to which the present disclosure pertains, unless specifically defined and described otherwise, and generally used terms, such as predefined terms, may be interpreted in consideration of the contextual meaning of the related art.

Furthermore, the terms used in the examples of the present disclosure are for describing the examples and are not intended to limit the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all combinations of the listed items. For example, "at least one of A or B" may refer to (1) at least one A; (2) at least one B; or (3) at least one A and at least one B.

In addition, in describing the constituent elements of the examples of the present disclosure, terms such as first, second, A, B, (a), (b), etc., may be used.

These terms are only for distinguishing the constituent element from other constituent elements, and the essence, order, or sequence of the constituent element is not limited by the term.

And, when a constituent element is described as being 'connected', 'coupled', or 'joined' to another constituent element, it may include not only cases where the constituent element is directly connected, coupled, or joined to the other constituent element, but also cases where it is 'connected', 'coupled', or 'joined' through another constituent element between the constituent element and the other constituent element.

In addition, when it is described as being formed or placed "on (top of) or under (below)" each constituent element, on (top of) or under (below) includes not only cases where the two constituent elements are in direct contact with each other but also cases where one or more other constituent elements are formed or placed between the two constituent elements. In addition, when expressed as "on (top of) or under (below)," it may include the meaning of not only the upward direction but also the downward direction based on one constituent element.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium to be executed on a computer. The medium may either continuously store a computer-executable program or temporarily store the program for execution or download. Furthermore, the medium may be a variety of recording or storage means in the form of a single hardware device or multiple combined hardware devices and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous-driving settings (e.g., an autonomous-driving classification or a selected autonomous-driving level). Based on the feature of Mitigating Sudden-Steering via Smooth Path Convergence Control, the vehicle may automatically smooth a sudden lane-change cancellation, a rapid path shift caused by updated map information, or a steering jump due to corrected positioning data. The vehicle control may include various operational controls associated with the vehicle (e.g., autonomous-driving control, sensor control, braking control, braking-time control, acceleration control, acceleration-change-rate control, alarm-timing control, or forward-collision-warning-time control), and these controls may be adaptively adjusted so that the vehicle follows the generated smooth convergence path rather than reacting abruptly.

One or more auxiliary devices (e.g., engine brake, exhaust brake, hydraulic retarder, electric retarder, regenerative brake, etc.) may also be controlled based on the feature of Mitigating Sudden-Steering via Smooth Path Convergence Control. For example, when a sudden steering change is smoothed into a convergence path, the vehicle may pre-adjust auxiliary braking force to stabilize deceleration, increase regenerative-brake capture during a gentle path transition, or reduce retarder torque to avoid abrupt lateral load shifts. One or more communication devices (e.g., a modem, a network adapter, a radio transceiver, an antenna, etc., capable of communicating via protocols such as Ethernet, Wi-Fi, NFC, Bluetooth, LTE, 5G NR, or V2X) may also be controlled based on the feature of Mitigating Sudden-Steering via Smooth Path Convergence Control. For example, when a sudden steering change is smoothed into a convergence path, the vehicle may prioritize V2X broadcasts to nearby vehicles to announce a stabilized trajectory, temporarily increase GNSS or map-updating frequency to refine path accuracy, or suppress non-critical data transmissions to secure bandwidth for path-convergence messaging.

Minimum risk maneuver (MRM) operation(s) may also be controlled based on the feature of Mitigating Sudden-Steering via Smooth Path Convergence Control. A minimal risk maneuvering operation (e.g., a minimal risk maneuver, a minimum risk maneuver) may be a maneuver of a vehicle to minimize a risk of collision with surrounding vehicles to reach a lowered risk state. A minimal risk maneuver may be activated during autonomous driving when a driver is unable to respond to a request to intervene. During the minimal risk maneuver, one or more processors of the vehicle may control a driving operation of the vehicle for a set period of time by smoothing any sudden steering deviation into a controlled convergence path, such as gently guiding the vehicle toward a safe shoulder, stabilizing lateral motion while reducing speed, or aligning the vehicle with a detected safe stop area without abrupt directional changes.

Biased driving operation(s) may also be controlled based on the feature of Mitigating Sudden-Steering via Smooth Path Convergence Control. A driving control apparatus may perform a biased driving control by maintaining a lateral distance between the position of the center of the vehicle and the center of the lane. For example, the driving control apparatus may control the vehicle to stay in the lane but not at its center. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. When a sudden steering change is smoothed into a convergence path, the system may bias the vehicle toward one side of the lane to create a safer buffer from an adjacent vehicle, gently drift toward a lane boundary to avoid roadside obstacles, or maintain a stable offset during a gradual path transition to reduce lateral load shifts.

One or more sensors (e.g., IMU sensors, camera, LIDAR, RADAR, blind-spot monitoring sensor, lane-departure warning sensor, parking sensor, light sensor, rain sensor, traction-control sensor, ABS sensor, tire-pressure sensor, seatbelt sensor, airbag sensor, fuel sensor, emission sensor, throttle-position sensor, inverter, converter, motor controller, power-distribution unit, high-voltage wiring and connectors, auxiliary power modules, charging interface, etc.) may also be controlled based on the feature of Mitigating Sudden-Steering via Smooth Path Convergence Control. An operation control for autonomous driving of the vehicle may include various driving controls by the vehicle control device (e.g., acceleration, deceleration, steering, braking, traction control, stability control, cruise control, lane-keeping assist, collision-avoidance control, emergency brake assistance, traffic-sign recognition, adaptive headlight control, etc.). For example, when a sudden steering change is smoothed into a convergence path, the system may temporarily increase camera or LIDAR frame rates to sharpen lane-edge detection, widen RADAR tracking of adjacent vehicles during gentle lateral shifts, or adjust IMU filtering parameters to refine curvature estimation during the smooth transition.

An autonomous driving level and/or autonomous driving activation/deactivation may also be controlled based on the feature of Mitigating Sudden-Steering via Smooth Path Convergence Control. A driving control apparatus may perform an autonomous-driving-level control (e.g., a change of an autonomous-driving level or a change of a required user attentiveness) or cause deactivation of an autonomous driving operation. For example, by changing the required user attentiveness, the driver may be required to place his/her hands on the steering wheel more often (e.g., at least once in a threshold time period, such as five seconds, 30 seconds, or one minute). By changing the required user attentiveness, the driver may be required to look ahead more often (e.g., at least once in a threshold time period). By changing the autonomous-driving level, one or more video contents may not be displayed on a display of the vehicle. When a sudden steering change is smoothed into a convergence path, the system may temporarily elevate the autonomous-driving level to maintain stable control during the transition, automatically prevent deactivation until the smooth convergence is completed, or restrict hands-off allowance if the vehicle detects sustained steering irregularities even after applying the convergence strategy.

In the various flowcharts of this document, at least some of the steps may be omitted or their mutual order may be changed, and at least some of the various examples of this document may be performed at a specific point in time of each step of the flowchart. The operations of the various flowcharts in this document may be performed by at least one of the control device 100, the processor 130, and the autonomous vehicle 10. In addition, redundant contents in the drawings of this document may be omitted. In this document, the 'control device 100' may also be referred to as an 'autonomous vehicle control device 100'.

The 'driver control assistance system' mentioned in this document refers to hardware and software that can assist the driver in continuously controlling the longitudinal and lateral movements of the vehicle. Such a driver control assistance system may be referred to as an 'autonomous driving system' or 'system' in this document.

A 'Feature' mentioned in this document may mean a specific system function that aids the driver in a defined traffic scenario, situation, and system boundary.

'Dynamic Control' mentioned in this document may mean performing the operational and tactical functions necessary to move the vehicle in real time. This may include control of the vehicle's lateral and longitudinal movements, monitoring of the road environment, responding to events in the road traffic environment, operational planning, and signaling.

'System Boundaries' mentioned in this document may mean verifiable or measurable limits or conditions set by the manufacturer, up to or within the scope of conditions that affect a system or system's function designed to provide assistance to the driver and the system's ability to operate as intended.

Each step of the flowcharts mentioned in this document may be described as being performed by the processor 130 of the autonomous vehicle 10, but is not limited thereto, and the control device 100 or the autonomous vehicle 10 itself may perform the example of each step.

According to the present disclosure, sudden and abrupt steering changes that may occur during autonomous driving of a vehicle (e.g., when a lane change is canceled, when map information is updated, or when a detected vehicle position is corrected, etc.) may be mitigated by causing the vehicle to follow a smooth and continuous path instead of abruptly switching from one path to another. When a steering control amount suddenly changes, the vehicle may identify a start point based on a travel path at a first time point and an end point based on a travel path at a second time point and may generate a convergence path that gradually connects these two points. In generating the convergence path, the vehicle may consider a speed of the vehicle, road curvature, allowable lateral acceleration, and surrounding-vehicle behavior. The vehicle may also set one or more intermediate points or sub-points between the start point and the end point to shape the convergence path so that the transition occurs naturally without abrupt movements. By controlling travel based on the generated convergence path, the present disclosure enables improved driving stability, safer path transitions, and enhanced ride comfort in situations involving sudden steering changes.

Hereinafter, examples will be described in detail with reference to the accompanying drawings, but the same or corresponding constituent elements will be given the same reference numbers regardless of the drawing symbols, and redundant descriptions thereof will be omitted.

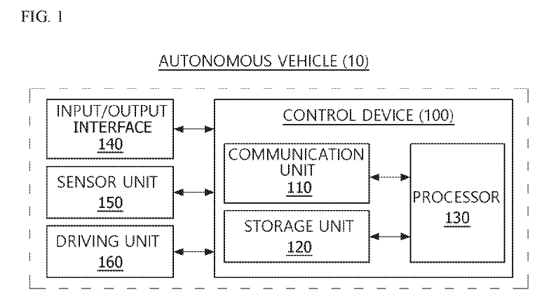

FIG. 1 shows an example of a configuration diagram of an autonomous vehicle 10.

The autonomous vehicle 10 may include a control device 100, a communication unit 110, a storage unit 120, a processor 130, an input/output interface 140, a sensor unit 150, and a driving unit 160. Each of these components in FIG. 1 may be implemented inside the vehicle (e.g., mounted in an ECU compartment, integrated into a dashboard module, or embedded within a sensor housing, etc.).

The autonomous vehicle 10 can be dynamically controlled in various driving situations through an autonomous driving system. For example, the autonomous driving system can provide both driving stability and convenience through longitudinal control (acceleration and deceleration) and lateral control (lane keeping and changing) of the autonomous vehicle 10 (e.g., maintaining a set speed, centering the vehicle within a lane, or performing an automated lane change, etc.). Such an autonomous driving system monitors the driving environment through sensors and a control device, and processes data in real time to adjust the vehicle's position, driving speed, direction, and the like based on detected road and traffic conditions.

The control device 100 may be formed integrally with the internal components of the vehicle, or may be implemented as a separate independent device from other components inside the autonomous vehicle 10 and communicate with the internal components of the vehicle through various connection means (e.g., CAN bus, wireless network, wired connection, or Ethernet links, etc.). The control device 100 includes a communication unit 110, a storage unit 120, and a processor 130 to manage the longitudinal and lateral control of the vehicle, and may additionally include other components such as an input/output interface 140, a sensor unit 150, and a driving unit 160 to perform complex control functions according to the driving situation (e.g., emergency braking, autonomous steering, or path-following control, etc.).

The control device 100 may store data collected from the sensor unit 150 during driving in the storage unit 120 and process it in real time to control the safety and convenience functions of the vehicle. For example, the control device may perform overall control and management of the autonomous driving system, such as providing a notification (e.g., a warning sound, dashboard alert, or HUD display, etc.) in a situation where driver intervention is required based on data detected from the sensor unit 150.

The control device 100 can display the vehicle control status through a user interface linked with an HMI (Human-Machine Interface) based on various driver settings and driving conditions, or receive driver input to control driving functions (e.g., selecting autonomous mode, adjusting following distance, or modifying lane-change behavior, etc.).

According to an example of the present disclosure, the control device 100 may calculate a change value of a steering control amount by comparing the vehicle path at a first time point and the vehicle path at a second time point. When the change value exceeds a preset threshold, the control device 100 may set a start point based on a control target point, an end point considering the vehicle speed and curvature, and an intermediate point between them. A path convergence strategy reflecting a reference line may be performed based on each of these points, and a convergence path may be generated by the control device 100 to ensure smooth transition of steering control.

The communication unit 110 performs communication with other control devices inside the vehicle to share data between systems or can transmit and receive various information through connection with the outside of the vehicle. The communication unit 110 uses various in-vehicle communication methods such as CAN communication and Ethernet to transmit control signals and data between internal components, and can link driving information and external data in real time through communication with a user terminal, other vehicles (V2V: Vehicle-to-Vehicle), infrastructure (V2I: Vehicle-to-Infrastructure), or an external server (e.g., cloud-based map services or traffic-information platforms, etc.).

The communication unit 110 can perform short-range communication, GNSS (Global Navigation Satellite System) module operations (e.g., GPS module), V2X (Vehicle-to-Everything) communication, optical communication, broadcast transmission/reception, and ITS (Intelligent Transport Systems) communication functions. For example, the communication unit 110 can support stable data transmission at close range using various wireless communication technologies such as Bluetooth, RFID (Radio Frequency Identification), IrDA (Infrared Data Association), UWB (Ultra-Wideband), ZigBee, NFC (Near Field Communication), Wi-Fi, Wi-Fi Direct, and Wireless USB. In addition, it can perform long-distance communication through mobile communication modules based on mobile communication networks such as LTE and 5G and wireless Internet modules to receive real-time data or link with the cloud, thereby improving the performance of the autonomous driving system (e.g., real-time map updates or remote diagnostics, etc.).

The storage unit 120 may include various types of memory that can store data and may be integrated within the control device 100 or the processor 130 or configured as a separate module. The storage unit 120 may include non-volatile memory (e.g., hard disk drive, flash memory, solid-state storage, etc.) and volatile memory, and may combine them to implement a memory system of various capacities and performances.

According to an example, the storage unit 120 may include a memory that can store and manage various data related to the autonomous driving system (e.g., map data, sensor fusion results, or driver-preference settings, etc.).

According to an example of the present disclosure, the storage unit 120 may temporarily store path generation history data, including start point, end point, intermediate point, and reference line information used for generating a convergence path for subsequent validation or recalculation.

According to an example of the present disclosure, the storage unit 120 may provide a memory including at least one instruction. These instructions may be executed by the processor 130 to perform functions such as determining whether the steering control amount has suddenly changed, setting points, setting a reference line, and generating a convergence path (e.g., using polynomial fitting, spline interpolation, or curvature-based smoothing, etc.).

The storage unit 120 may store various data related to the convergence path generation strategy of the present disclosure, such as vehicle path information at each time point, steering control history, coordinates of the reference line, start point, intermediate point, and end point positions, curvature-based distance data, convergence path shape data, coordinates of sub-points (e.g., a first sub-point, a second sub-point, or an additional auxiliary point, etc.), and convergence path output.

The subject of the operations performed in the following drawings may be the processor 130, the autonomous vehicle control device 100, the autonomous vehicle 10, or the instructions stored in the storage unit 120.

The processor 130 communicates with various internal components of the communication unit 110, the storage unit 120, the input/output interface 140, the sensor unit 150, the driving unit 160, and the autonomous vehicle 10 through electrical or operational connections, and can control the operation of each component and perform data processing. The processor 130 is a central processing unit for executing instructions and calculating data, and can collect, process, and analyze data in real time according to the vehicle's driving environment to perform vehicle control (e.g., path planning, collision avoidance, or adaptive-cruise-control adjustments, etc.).

The processor 130 may be implemented in the form of hardware, software, or a combination thereof, and for example, may perform vehicle control logic in the form of a microcontroller, FPGA, or ASIC. In addition, it may include a multi-processor configuration for the control of complex autonomous driving and driver assistance systems. Such a processor configuration can support comprehensive control and stable performance of the vehicle through the execution of autonomous driving and assistance systems, sensor data processing, communication data management, and driving-related judgment functions (e.g., risk assessment or maneuver selection, etc.).

According to an example of the present disclosure, the processor 130 can execute calculation logic for setting a reference line, setting points, and generating a convergence path based on predefined path-optimization rules.

The input/output interface 140 serves to receive input related to vehicle control from a user and to transmit the control status of the vehicle and system operation information to the user.

The input/output interface 140 can perform the function of receiving various inputs from the user and delivering the vehicle control status to the user. For example, the input/output interface 140 may include at least one of input through physical buttons provided inside the autonomous vehicle 10, input through soft buttons displayed on the display of the autonomous vehicle 10, user's voice input, and user's gesture input (e.g., swipe gestures or touch-based commands, etc.).

According to an example of the present disclosure, the input/output interface 140 can deliver the convergence path, the path switching timing, and related status information to the driver through output means such as a display device, cluster, or HUD (e.g., overlaying predicted vehicle trajectory or lane-change advisories, etc.).

The input means may include physical buttons, soft keys on a touch display, a voice recognition function, a gesture recognition function, and the like, through which the user can input commands such as an autonomous driving system activation request, function switching, or driving assistance setting.

In addition, the input means can receive user input through an input device provided on the steering wheel of the autonomous vehicle 10. For example, through buttons mounted on the steering wheel, the driver can input a command to activate or deactivate the autonomous driving system even while driving. Such steering wheel-based input can support the user to quickly control the autonomous driving function by providing an intuitive interface (e.g., toggling cruise control or adjusting lane-change aggressiveness, etc.).

The output means includes a display, an audio module (e.g., a speaker), a haptic module, and the like, and can provide the status of the autonomous driving system, control switching request notification, function activation status, etc. to the user in visual, auditory, and tactile forms (e.g., screen alerts, warning tones, or steering-wheel vibrations, etc.).

In addition, the status of the autonomous driving system can be intuitively checked through a head-up display (HUD), a cluster, an AVN (Audio Video Navigation), and a display embedded in a rear mirror or a side mirror (e.g., lane-change guidance or convergence-path overlays, etc.). In addition, the status of the autonomous driving system can be checked through a display of a console installed in each row of the autonomous vehicle 10, an application of a user terminal, and the like (e.g., a smartphone app or tablet-based passenger console, etc.).

The sensor unit 150 may include a number of sensors that support the stable operation of the autonomous driving system by detecting various driving and environmental information in real time. The sensor unit 150 can measure the distance and speed to surrounding objects through long-range detection sensors such as RADAR (Radio Detection and Ranging) and LIDAR (Light Detection and Ranging), and can include an ultrasonic sensor to detect objects near the autonomous vehicle 10 (e.g., curbs, bicycles, or pedestrians, etc.).

In addition, the sensor unit 150 includes a position sensor such as GPS to collect position information of the autonomous vehicle 10, and includes an optical sensor to provide ambient illuminance information so that the system can respond to changes in light (e.g., detecting tunnels, nighttime conditions, or sudden glare, etc.). In addition, the sensor unit 150 may include an accelerator pedal and a brake pedal sensor, a steering wheel detection sensor, a seating sensor, and the like to monitor the driving control status of the autonomous vehicle 10 and user behavior (e.g., seat-occupancy detection or steering-wheel torque sensing, etc.).

The sensor unit 150 may include a camera. The camera can be classified into an external camera and an internal camera. The external camera recognizes the road and the surrounding environment, and the internal camera detects the driver's condition (e.g., eye tracking, drowsiness detection) or the indoor situation to comprehensively grasp the situation inside and outside the vehicle (e.g., passenger movement or object-left-behind detection, etc.).

The sensor unit 150 may include a heart rate sensor, a pressure sensor, an infrared sensor, and the like to collect a driver's biometric information or various environmental data (e.g., cabin temperature, CO₂ level, or hand-gesture patterns, etc.).

According to an example of the present disclosure, the sensor unit 150 can collect data related to the generation of a convergence path. For example, the current speed of the vehicle 10, heading, yaw rate, position information, steering angle, lane recognition result, road curvature, position of surrounding objects, and the like may be collected through the sensor unit 150 (e.g., forward vehicles, roadside objects, or merging-lane geometry, etc.).

The driving unit 160 provides the driving force necessary for the driving of the autonomous vehicle 10 and may include various constituent elements that control the operation of the vehicle according to a command output from the control device 100. The driving unit 160 may be composed of devices that generate and transmit the power of the vehicle, such as an engine, a motor, a transmission, and a wheel drive system, and a controller that controls them, and through these components, acceleration, deceleration, and direction change of the autonomous vehicle 10 can be performed (e.g., initiating a lane change or adjusting cornering force, etc.).

The driving unit 160 can be controlled to maintain driving safety by performing longitudinal control (acceleration and deceleration) and lateral control (lane keeping and changing) of the vehicle. For example, it receives a command from the control device 100 to adjust the output of the motor or adjust the rotation speed and direction of the wheels so that the vehicle can follow the travel path (e.g., reducing motor torque to match curvature or increasing wheel rotation for overtaking, etc.).

In addition, the driving unit 160 may include a brake system to reduce the vehicle speed or stop during driving. The driving unit 160 can control the autonomous vehicle 10 through an electric motor in the case of an electric vehicle and based on the engine output in the case of an internal combustion engine vehicle (e.g., hybrid vehicles coordinating both systems, etc.).

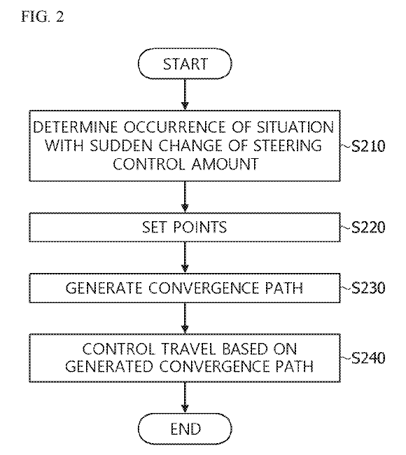

FIG. 2 shows an example of an autonomous vehicle control method.

The control device 100 may determine whether a situation in which a steering control amount suddenly changes occurs (S210).

Specifically, the control device 100 may execute an instruction stored in the storage unit 120 to compare vehicle path information between time points adjacent to each other and calculate a change value of steering control amount accordingly (e.g., comparing curvature, lateral offset, or path heading, etc.).

After extracting path data at a first time point and a second time point, which is after the first time point, the control device 100 may confirm an amount of change in steering angle of corresponding paths and determine whether the amount of change in the steering angle exceeds a preset threshold value based on predefined stability criteria.

A path at the first time point and the second time point may mean a reference line or a travel trajectory and may include a vehicle position, a travel direction, a curvature, a path coordinate, and the like. The path information may be generated based on information such as a vehicle position, a steering angle, a yaw rate, and a lane recognition result collected from the communication unit 110 or the sensor unit 150 (e.g., camera-based lane markers or LiDAR-based boundary detection, etc.).

The control device 100 may detect, for example, a case where a strategy is interrupted during a lane change, a case where camera-based road information is switched to a fine map-based path, or a case where a path is suddenly changed due to positioning error correction (e.g., GNSS drift or map-matching correction, etc.). The control device 100 may confirm a change value (e.g., a lateral error) of steering control amount from a previous path at a control target point and check whether the change value exceeds a preset value.

The control device 100 may set one or more points (S220).

When it is determined that the change value of the steering control amount is greater than or equal to a preset value, the control device 100 may set points for path convergence. The points may include a start point, an end point, and an intermediate point configured for smooth path transition.

The start point may be any position of a travel path at a time point prior to a sudden change (e.g., a first time point). For example, the start point may be set to one of a control target point of the travel path set at a first time point or a point on a reference line set based on the travel direction of a vehicle. Here, the reference line may be defined as an extended line of a vehicle in a heading direction of the current vehicle or an extended line of a previous path (e.g., a forward-projected centerline or a predicted path segment, etc.).

The control device 100 may confirm a current speed of the vehicle and a regulatory allowable lateral acceleration (e.g., a legal lateral-acceleration limit or vehicle-specific stability bound, etc.) to set the end point. The control device 100 may calculate a lower limit value and an upper limit value of a longitudinal distance for which the end point may be set based on the current speed and the regulatory allowable lateral acceleration and then determine the end point within the range of the distance. This end point may be any position of the travel path generated at a second time point (e.g., a predicted path coordinate or a map-matched lane-center position, etc.).

The end point may be selected within the range of the lower limit value and the upper limit value of the longitudinal distance in consideration of, for example, the position of a surrounding vehicle, stopping of a preceding vehicle, and the like (e.g., cut-ins, sudden braking ahead, or nearby obstacles, etc.). The lower limit value may be calculated as a distance corresponding to a minimum radius of curvature satisfying a regulatory allowable lateral acceleration, and the upper limit value may be calculated as a distance based on a gentle radius of curvature in consideration of ride comfort (e.g., reduced jerk or minimized steering load, etc.).

The intermediate point may be set to any position between the start point and the end point. For example, the control device 100 may form an imaginary curve connecting the start point and the end point and designate a middle position of the curve as an intermediate point. For example, the control device 100 may calculate a length (e.g., an arc length) from the start point to the end point and set a middle point to be positioned between a travel lane of a vehicle and a target lane (e.g., at a center offset between both lanes, etc.).

Next, the control device 100 may generate a convergence path (S230).

The control device 100 may generate a convergence path connected to the current driving state of the vehicle based on the start point, the intermediate point, and the end point set in Step S220. The converging path is a smooth continuous path that prevents driving behavior of the vehicle from suddenly changing from a suddenly changing path and allows the vehicle to naturally move to a new path along a previous control target point or travel trajectory (e.g., smoothing abrupt curvature changes or reducing lateral-jerk spikes, etc.).

The control device 100 may use a multi-dimensional path generation algorithm to determine a curve shape between a start point and an intermediate point, and between an intermediate point and an end point. For example, the control device 100 may utilize a mathematical technique such as B-spline (e.g., cubic B-spline or non-uniform rational B-spline, etc.).

According to an example of the present disclosure, the control device 100 may generate a convergence path based on a start point and an end point. The control device 100 may generate a convergence path using the start point and the end point set through the multi-dimensional path generation algorithm (e.g., by optimizing curvature or minimizing lateral movement, etc.).

According to an example of the present disclosure, the control device 100 may generate a convergence path based on a start point, an end point, and an intermediate point.

According to an example of the present disclosure, the control device 100 may further set a first sub-point and a second sub-point in addition to a start point, an intermediate point, and an end point to generate a convergence path. The first sub-point is set to control that sudden steering does not occur at the start point, and the second sub-point may be used as a reference point for mitigating a steering change amount in a connection from the intermediate point to the end point. In consideration of a positional relationship between these points, the control device 100 may design a path shape so that the change in a steering angle for each section is gentle (e.g., limiting curvature peaks or distributing steering load, etc.).

The convergence path may be generated by comprehensively considering longitudinal distance, amount of lateral movement, vehicle speed, expected lateral acceleration, radius of curvature, and the like with reference to a travel direction. For example, the control device 100 may adjust the positions of a first sub-point and a second sub-point based on a gain value calculated according to vehicle speed, a distance between a start point and an end point, and a curvature difference between a lane in which the vehicle is traveling and a target lane (e.g., merging maneuvers or exit-ramp transitions, etc.).

The control device 100 may control the vehicle based on the generated convergence path (S240).

The control device 100 may calculate a travel control signal of the vehicle to be able to follow the convergence path generated in Step S230 and transmit the travel control signal to the driving unit 160. To this end, the control device 100 may generate and transmit a steering angle of the vehicle 10, an acceleration/deceleration instruction, or a control instruction for the vehicle speed based on the generated convergence path to the driving unit 160 (e.g., torque commands, wheel-angle commands, or brake-pressure control, etc.).

Furthermore, the generated convergence path may be provided in a visual, audible, or tactile form to a user in an external device or vehicle 10 via through input/output interface of the control device 100. For example, the control device 100 may output the convergence path information to a display or an HUD to output the progress of path switching or the shape of a current path (e.g., highlighting the upcoming merging trajectory, etc.).

Meanwhile, the control device 100 may transmit the generated convergence path to another device (e.g., a server or a user terminal) through the communication unit 110 of the vehicle for logging, diagnostics, or cooperative-driving coordination.

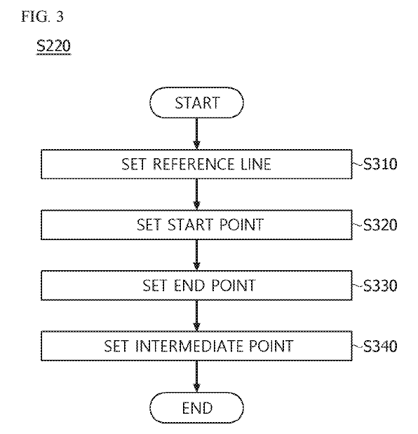

FIG. 3 shows an example of a point setting method. FIG. 3 may specify Step S220 (point setting) of FIG. 2. In the contents of FIG. 3, contents overlapping with those of FIG. 2 are omitted or briefly described.

The control device 100 may set a reference line (S310).

Specifically, the control device 100 may generate a reference line reflecting a travel direction of a vehicle. The reference line is used as a reference axis for defining a start point that is set in a later step and may provide directionality so that a vehicle 10 may smoothly enter a convergence path from a suddenly changing path (e.g., during cut-in avoidance or lane-merge recovery, etc.).

For example, the reference line may be set to be a straight line formed along a travel direction of a vehicle from a control target point at an immediately preceding time point t−1 of the vehicle. The travel direction of the vehicle 10 may be calculated by reflecting a heading value, a yaw rate, a steering angle, or the like of the vehicle 10 (e.g., high curvature turns or gentle highway sweeps, etc.). The reference line may be generated based on the speed of the vehicle, the radius of curvature, and the like and may be set in consideration of movement characteristics and continuity of the vehicle 10.

In addition, the reference line may be formed by being fused with external sensor-based information to reflect a road shape or a lane recognition result. The control device 100 may adjust the reference line so that the reference line may maintain the directionality and continuity of the start point of the vehicle to be set at a current time point (e.g., smoothing noise from perception or map-matching errors, etc.).

Next, the control device 100 may set a start point (S320).

The control device 100 may set a start point for generating a convergence path based on a traveling state at a time t−1 before a steering control amount of the vehicle changes suddenly. The start point is set to reflect the control criteria that were present immediately before the vehicle entered a suddenly changing path and may be used as a start point of a convergence path to ensure continuity and stability of vehicle behavior (e.g., preserving previous path curvature or maintaining safe lateral offset, etc.).

According to an example of the present disclosure, the start point may be set as a control target point at a first time point t-1 when a vehicle 10 is under control. This control target point may be a reference point set along a previous path of the vehicle 10, reflecting a state in which the vehicle 10 was moving along an original path to that point (e.g., a previously computed lane-center coordinate or a smoothed predicted trajectory point, etc.).

In addition, the start point may be set to be a point on a reference line formed to reflect a travel direction of a vehicle. In this case, the control device 100 may set a point that has progressed by a certain distance along the reference line formed in Step S310 of FIG. 3 as a start point (e.g., several meters ahead along the heading vector, etc.).

The control device 100 may set an end point (S330).

The control device 100 may set an end point of a convergence path based on current travel path information of a vehicle and a vehicle dynamic condition. The end point is a final convergence point that a vehicle has to reach on a changed path and may be set with reference to a longitudinal distance in consideration of a speed and a lateral acceleration reference of the vehicle (e.g., a permissible lateral-acceleration profile or stability threshold, etc.).

According to an example of the present disclosure, the control device 100 may first calculate a lower limit value and an upper limit value of a longitudinal distance for setting an end point.

The control device 100 may calculate the lower limit value and the upper limit value of the longitudinal distance for setting the end point, based on a speed and a regulatory allowable first lateral acceleration of the vehicle. The control device 100 may set an end point on a convergence path of the vehicle within a distance range between the lower limit value and the upper limit value. The end point may be an end point of the convergence path and may be a reference point at which the vehicle finishes switching to a new path (e.g., a final target position on the new lane, etc.).

The control device 100 may calculate the minimum radius of curvature using the speed of the vehicle and a regulatory allowable first lateral acceleration as input values and may calculate the minimum longitudinal distance that may be physically traveled according to the calculated minimum radius of curvature to derive the lower limit value.

For example, the lateral acceleration should be less than or equal to 3 m/s² when the vehicle is kept in a lane at a level higher than or equal to a predetermined autonomous driving level, and in other situations, less than or equal than 3.5 m/s², and the control device 100 may calculate the physical radius of curvature based on this limitation and calculate a minimum longitudinal distance (lower limit) corresponding to the radius (e.g., using standard lateral-acceleration equations or curvature models, etc.).

The control device 100 may calculate a gentler radius of curvature (e.g., a maximum radius of curvature) based on the speed of the vehicle and a second lateral acceleration which is set to a value smaller than the regulatory allowable value and may calculate a maximum longitudinal distance corresponding to the calculated radius of curvature to derive an upper limit value. More specifically, the control device 100 may calculate the maximum radius of curvature at which the vehicle may stably rotate, based on the second lateral acceleration which is set to a value smaller than the regulatory allowable lateral acceleration (e.g., for comfort-oriented steering profiles, etc.).

The control device 100 may calculate the speed, the maximum radius of curvature, based on the speed of the vehicle and the second lateral acceleration. Thereafter, the control device 100 may calculate, based on the maximum radius of curvature, a maximum longitudinal distance at which the vehicle may change direction while satisfying the curvature condition and set the maximum longitudinal distance as the upper limit value of the end point (e.g., a farthest safe transition point under comfort constraints, etc.).

For example, the upper limit value may be calculated based on a lateral acceleration (e.g., 2.0 m/s²) that is smaller than the regulatory allowable value in consideration of the ride comfort.

Within the distance range between the calculated lower limit value and the calculated upper limit value, the control device 100 may set the end point. The position of the end point may be determined by further reflecting traffic conditions around the vehicle.

For example, when another vehicle is present in a lane next to the vehicle 10, a lower limit value or a point adjacent to the lower limit value may be set as an end point because faster convergence is required (e.g., to avoid lateral conflict with adjacent traffic, etc.).

For another example, when it is determined that the front vehicle is stopped or is to be stopped (e.g., acceleration is reduced) in the lane in which the vehicle 10 is traveling, the end point may be set to a part of the front vehicle or a point adjacent to the front vehicle (e.g., a safe following-distance point, etc.).

As another example, the upper limit value may be set as an end point when there is no obstacle such as another vehicle in a surrounding lane (e.g., an adjacent lane) of the vehicle 10 (e.g., open-lane merging or empty-lane convergence, etc.).

In this way, the control device 100 may set the end point by reflecting the speed of the vehicle, road environment, and surrounding object information.

Next, the control device 100 may set an intermediate point (S340).

The control device 100 may set an intermediate point, based on the positions of the start point set in Step S320 and the end point set in Step S330, positioned between the two points. The intermediate point is used as a reference point for controlling the shape of the converging path and may be utilized to adjust the curvature and the amount of steering change of a path switching intermediate section (e.g., distributing curvature smoothly across segments, etc.).

According to an example of the present disclosure, the control device 100 may generate an imaginary curved line or straight line connecting the start point and the end point, and then set a point positioned at the center of the path as an intermediate point. The curve may be defined as a quadratic curve, a B-spline, or a polynomial shape according to the shape of the convergence path, and the control device 100 may calculate an arc length of the curve to calculate a center point (e.g., by numerical integration or spline-segment approximation, etc.).

The control device 100 may adjust the intermediate point so that the calculated intermediate point is positioned near a lateral movement boundary line between a traveling lane of the vehicle and a path after a sudden change, that is, the boundary at which the lane change occurs. For example, the intermediate point may be positioned near the center of the lane between a current path and a new path (e.g., mid-lane lateral position, etc.).

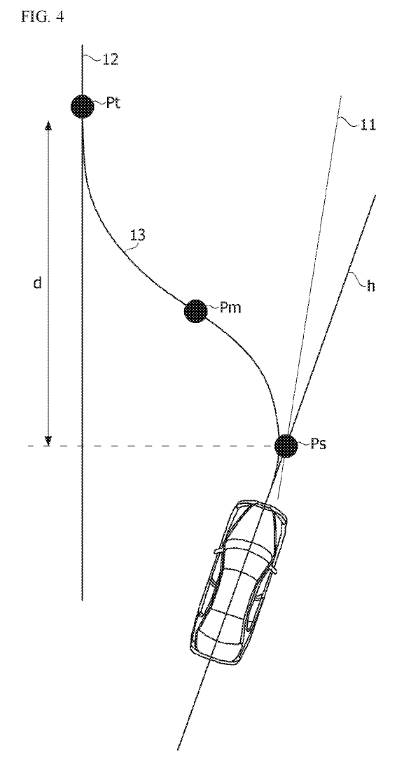

FIG. 4 shows an exemplary diagram for explaining a convergence path generation strategy. FIG. 4 illustrates a process of setting a convergence path based on a reference line and each point in a sudden path switching situation of the autonomous vehicle 10.

The autonomous vehicle 10 may face a situation switching to a suddenly changed travel path 12 while progressing along the reference line h. In the drawing, a reference line h reflecting the traveling direction of the vehicle is illustrated, and the reference line may be set along the heading direction of the vehicle (e.g., computed from yaw-rate and steering-angle data, etc.).

The control device 100 may set a control target point or a point on the reference line h at an immediately preceding time point t-1 of the vehicle as a start point ps. The start point ps is a start point of a convergence path and may reflect a vehicle state before convergence (e.g., lane-center tracking, previous heading direction, or prior steering target, etc.).

Thereafter, the control device 100 may set one of the points on a suddenly changed new path 12 as the end point pt. At this time, the longitudinal distance d may be set within a lower limit or an upper limit range determined according to the vehicle speed and the regulatory allowable lateral acceleration (e.g., safety limits defined by vehicle dynamics or legal lateral-acceleration constraints, etc.).

The control device 100 may set a center point pm between the start point ps and the end point pt as an intermediate point. This intermediate point pm may contribute to smoothing of the curvature of the converging path 13 by distributing curvature changes across segments.

The convergence path 13 generated in this way may be formed to start at the start point ps, pass through the intermediate point pm, and reach the end point pt (e.g., a three-point polynomial or spline-based curve, etc.).

As shown in FIG. 4, the control device 100 may set a start point, which is a path start point, a reference line, an end point, and an intermediate point, and generate a convergence path based on each point, so that the travel behavior according to the sudden change in the steering control amount may be stably controlled (e.g., reducing abrupt lateral movement or excessive steering inputs, etc.).

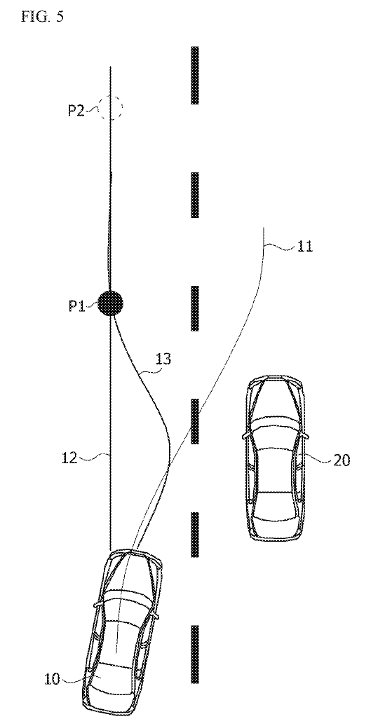

FIG. 5 shows an example of end point setting.

FIG. 5 corresponds to a case where another vehicle 20 is present in a lane next to the autonomous vehicle 10 and illustrates a situation in which the autonomous vehicle 10 generates a convergence path for quickly converging to a traveling lane in a sudden change path situation.

The vehicle 10 may travel along a current path 11 in which the vehicle has been traveling until an immediately preceding time point and detect a situation in which the vehicle 10 needs to be switched to a new path 12 according to a sudden change in road conditions, a strategic judgment, or the like (e.g., obstacle avoidance, sensor-based re-routing, or map correction, etc.). At this time, the vehicle 10 may set a point corresponding to the control target point as a start point with reference to the current path and generate a path 13 for converging to a new position on the suddenly changed path.

At this time, the control device 100 may set an end point P1 to a lower limit value of a longitudinal distance in consideration of the surrounding environment information, in particular, another vehicle 20 present in an adjacent lane. The end point P1 is set such that the convergence path suddenly returns to the traveling lane, which may reflect a situation in which rapid convergence is required because a risk of collision with a vehicle in an adjacent lane may increase when a lane change is delayed (e.g., approaching side traffic or narrowing available lane-change window, etc.).

An upper limit P2 of the end point is also illustrated in the path as a maximum convergence distance that may be set according to a regulation or a ride comfort criterion. However, in the situation of FIG. 5, a strategy of rapidly responding to the sudden change path by setting the end point P1 to a minimum distance is used with priority given to safety.

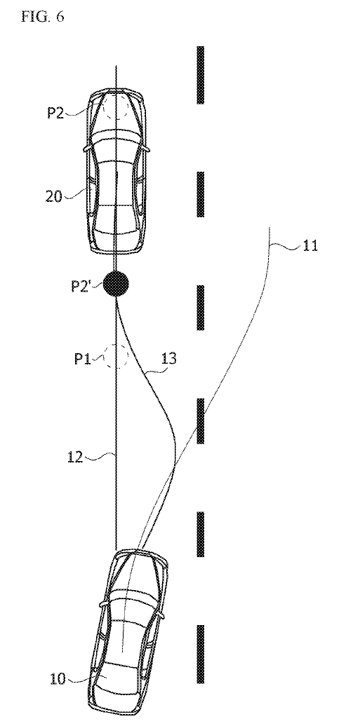

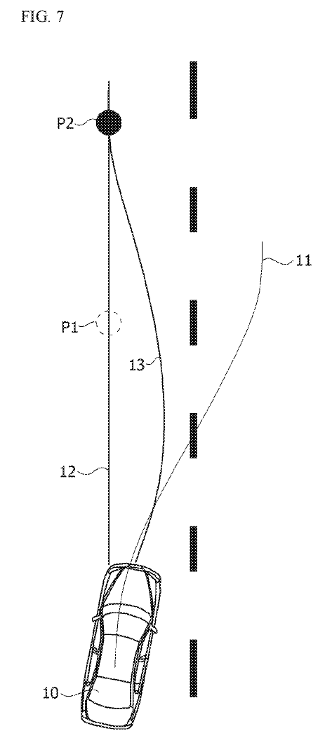

FIG. 6 shows an example of end point setting diagram.

FIG. 6 may be a diagram illustrating a situation in which the preceding vehicle 20 stops or is about to stop in the driving lane while the autonomous vehicle 10 is about to return to the driving lane (e.g., stop-and-go traffic or sudden braking of the leading vehicle, etc.).

The autonomous vehicle 10 may travel along a current path 11 and establish a new path 12 in response to a sudden path change situation. The control device 100 may set a convergence path 13 for path convergence at the start point by reflecting a current heading value (e.g., based on yaw rate or steering-angle data, etc.).

As illustrated in the drawing, P1 may be a lower limit value of an end point calculated based on a longitudinal distance, and P2 may be an upper limit value of an end point set based on a regulation or a ride comfort criterion. P2′ may be a selected end point set to reflect a stop position or an expected stop position of the preceding vehicle 20 (e.g., predicted stopping distance or braking-intention estimation, etc.).

The control device 100 may select an end point P2′ between the lower limit P1 and the upper limit P2, and in this case, whether the preceding vehicle 20 stops or decelerates may be considered. Since the vehicle should be able to travel without interference with a preceding vehicle even when the vehicle passes an end point, the control device 100 may determine an end point P2′ such that convergence is completed at a distance shorter than a stop position of the preceding vehicle (e.g., ensuring safe time-to-collision margin, etc.).

FIG. 7 shows an example of end point setting diagram.

FIG. 7 may show a situation in which, there is no other vehicle in the vicinity while an autonomous vehicle 10 is traveling, and the preceding vehicle is not scheduled to stop or decelerate. In this case, path convergence may be performed under relaxed conditions (e.g., prioritizing comfort over rapid maneuvering, etc.).

The autonomous vehicle 10 may travel along a current path 11 and set a new path 12 according to a sudden change in the steering control amount. The control device 100 may set a start point P1 and an end point P2 for convergence in the same manner as in FIG. 4. The converging path 13 generated at this time may be configured to smoothly continue from the start point P1 to the end point P2 (e.g., applying a gentle curvature transition, etc.).

As shown in the drawing, an end point P2 may be set to a set upper limit value of the end point, which may be calculated according to a lateral acceleration condition at a level lower than a regulatory allowable value. The end point P2 may be a longitudinal distance set in consideration of the ride comfort as a priority (e.g., minimizing steering-jerk or passenger discomfort, etc.).

In selecting an end point, the control device 100 may reflect a condition that there is no object around the vehicle and there is no preceding vehicle in a stopped or decelerated state in the traveling lane. Accordingly, the control device 100 may set an end point to the end point upper limit value and generate the path in a direction in which the curvature of the convergence path is relaxed to increase the ride comfort (e.g., a shallow curvature profile or extended transition distance, etc.).

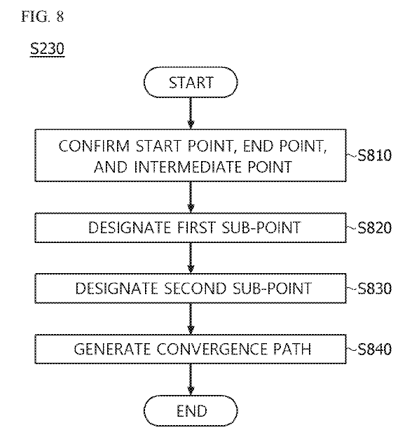

FIG. 8 shows a flowchart specifically illustrating a convergence path generation Step S230. Of the contents of FIG. 8, contents overlapping with those of FIGS. 2 and 3 are omitted or briefly described.

The control device 100 may generate a convergence path based on the start point Ps, the end point Pt, and the intermediate point Pm set in FIG. 3 (e.g., using spline-based or polynomial-based path construction, etc.).

The control device 100 may first identify three reference points including a start point Ps, an end point Pt, and an intermediate point Pm (S810).

These three path points may be used as main references for path convergence and serve as control reference points for curved paths that are formed later (e.g., curvature transition control or lateral-movement shaping, etc.).

The start point Ps may be set as a control target point at an immediately preceding time point t−1, and the end point Pt may be set as a point within the longitudinal distance calculated based on the regulation and the ride comfort criterion (e.g., lateral-acceleration limit or maximum-comfort curvature, etc.).

The intermediate point Pm may be designated as an intermediate position between the start point and the end point to distribute curvature evenly.

The control device 100 may set a first sub-point Sub1 on a first virtual straight line extending from a start point Ps in a traveling direction (S820).

The first sub-point Sub1 may be utilized as an auxiliary point for adjusting a curvature for entering an intermediate point Pm. The control device 100 may adjust the position of the first sub-point in consideration of the speed of the vehicle, the distance between the start point and the end point, the lane curvature, and the like (e.g., high-speed gentle curvature vs. low-speed tight curvature, etc.). At this time, a limit point Sub1_limit may be set based on the foot of the perpendicular drawn in a first tangential direction from the intermediate point, and the position of a second sub-point may be finally determined by multiplying the distance section by a gain Gain.

In order to correct the path shape between the intermediate point Pm and the end point Pt, the control device 100 may set a second sub-point Sub2 at a point where a straight line connecting the first sub-point and the intermediate point intersects with a second virtual straight line at the end point (S830).

The control device 100 may calculate a ratio between the length L2 of the altitude drawn in a second tangential direction from the intermediate point and the distance L3 between the end point and the second sub-point and adjust the position of the second sub-point so that the ratio is included within a preset range (e.g., to maintain curvature continuity or reduce steering-jerk spikes, etc.).

The control device 100 may sequentially connect the start point Ps, the first sub-point Sub1, the intermediate point Pm, the second sub-point Sub2, and the end point Pt to form a final convergence path (S840) using a continuous curvature profile.

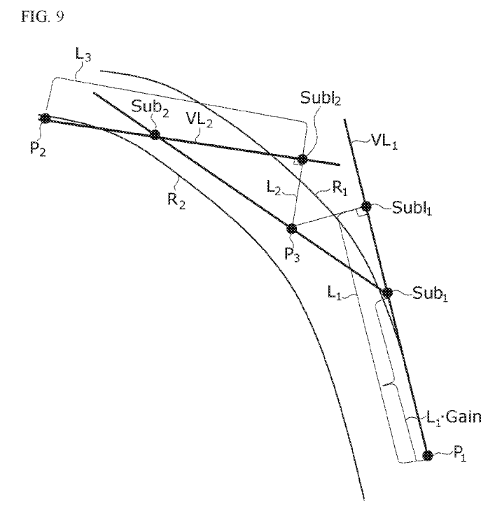

FIG. 9 shows a diagram illustrating a process of setting sub-points in a method for generating a convergence path.

Specifically, FIG. 9 illustrates a process in which a first sub-point Sub1 and a second sub-point Sub2 are set in addition to the start point P1, the end point P2, and the intermediate point P3. The drawing visualizes the control points for making the convergence path smoother and is based on an associated path generation algorithm (e.g., B-spline control-point configuration, etc.).

The control device 100 may set a reference tangent line VL1 in a traveling direction at the start point P1.

The control device 100 may lower an altitude from the intermediate point P3 in the direction of the reference tangent line VL1 and set the foot of the perpendicular to the first sub-point limit point Sub11.

The control device 100 may determine the position of the first sub-point Sub1 by multiplying the distance L1 between the start point P1 and the first sub-point limit point Sub1ₗ by a preset gain value Gain. In this case, the gain value may be adjusted according to the speed of the vehicle, the distance between the start point P1 and the end point P2, the difference in curvature, and the like (e.g., higher gain for high-speed merging or wider lane transitions, etc.).

For example, the control device 100 may increase the gain value as the speed of the vehicle increases or as the distance between the start point P1 and the end point P2 increases, so that the first sub-point Sub1 is set far in the reference tangential direction.

On the other hand, when the speed is slow or the end point P2 is close, the control device 100 may adjust the gain value to be small so that the first sub-point is set close to the start point P1 to reduce unnecessary lateral motion.

In addition, when the difference in curvature between the travel path and the target path is large, the control device 100 may set the position of the sub-point further away in order to alleviate the sudden centrifugal force transmitted to the occupant (e.g., reducing peak lateral acceleration, etc.).

The control device 100 may set a second sub-point Sub2 to a position where the straight line connecting the first sub-point Sub1 and the intermediate point P3 and the reference tangent line VL2 at the end point P2 intersect. At this time, the control device 100 may draw the perpendicular line in the direction of the reference tangent line VL2 at the intermediate point P3, set the foot thereof to the reference distance L2, and calculate the ratio of the distance L3 between the end point P2 and the second sub-point Sub2. When the ratio is out of a preset range, the control device 100 may adjust the position of the second sub-point Sub2 to ensure curvature continuity and control a smooth convergence path to be formed (e.g., smoothing curvature transitions or stabilizing steering response, etc.).

The control device 100 may then connect the start point P1, the first sub-point Sub1, the intermediate point P3, the second sub-point Sub2, and the end point P2 to form a final convergence path R2. The converging path R2 may be designed to reduce a sudden change of direction compared to the current path R1 and ensure steering stability and ride comfort (e.g., reducing steering-jerk spikes, limiting peak lateral acceleration, or smoothing curvature transitions, etc.) at the same time.

The control device 100 may automatically adjust the gain value according to various conditions such as the traveling speed of the vehicle, the road curvature, and the distance between the start point and the end point (e.g., higher gain for high-speed curved-lane entry, lower gain for short-distance path merging, etc.).

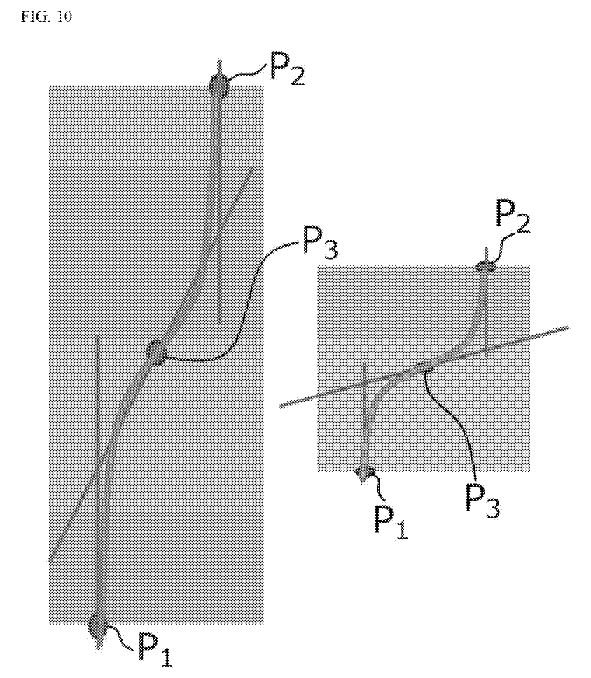

FIGS. 10-13 show diagrams illustrating a change in a convergence path formed according to a difference in a gain value setting in a convergence path generation process.

Referring to FIG. 10, it can be seen that when the position of a first sub-point Sub1 is designated using the same gain value Gain, the speed is relatively fast, and when the gain value Gain calculated in the left path in which the distance between the start point P1 and the end point P2 is relatively far away is applied to the right path to designate a first sub- point Sub1, a rapid steering change situation occurs. Such a sudden change in steering may not only reduce the ride comfort of the occupant but also increase anxiety (e.g., abrupt yaw-rate spikes or uncomfortable lateral sway, etc.).

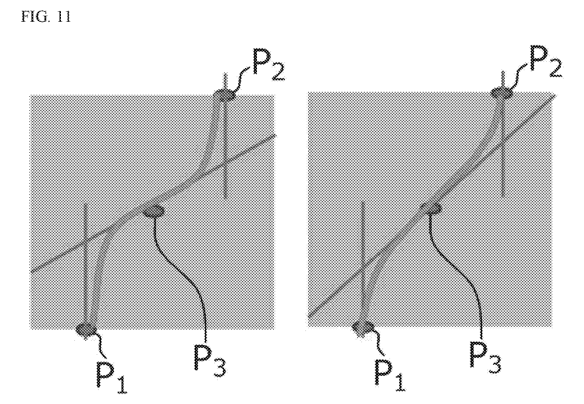

Referring to FIG. 11 together, when the speed of the vehicle is relatively slow and the distance between the start point P1 and the end point P2 is relatively close, the control device 100 may prevent a rapid steering change from occurring by adjusting the gain value Gain to be relatively small (e.g., using a tighter curvature profile at low speeds, etc.).

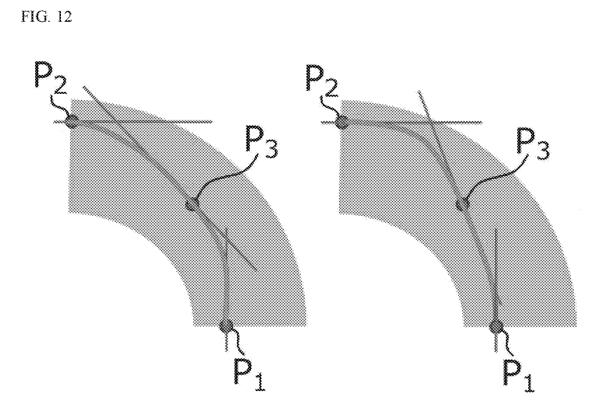

Referring to FIG. 12 together, when the control device 100 changes the lane from an inner lane having a large curvature to an outer lane having a relatively small curvature, it is possible to prevent a sudden change in steering from occurring by adjusting the gain value Gain in proportion to the curvature difference (e.g., increasing gain when transitioning from a sharp curve to a gentle curve, etc.).

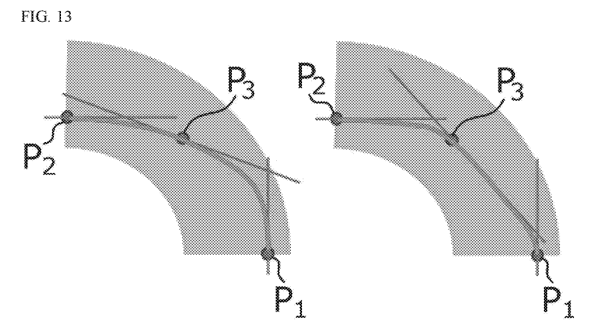

Referring to FIG. 13 together, when the control device 100 changes the lane from an outer lane having a small curvature to an inner lane having a relatively large curvature, it is possible to prevent a sudden change in steering from occurring by adjusting the gain value Gain in inverse proportion to the curvature difference (e.g., reducing gain when entering a sharper curve to avoid aggressive steering input, etc.).

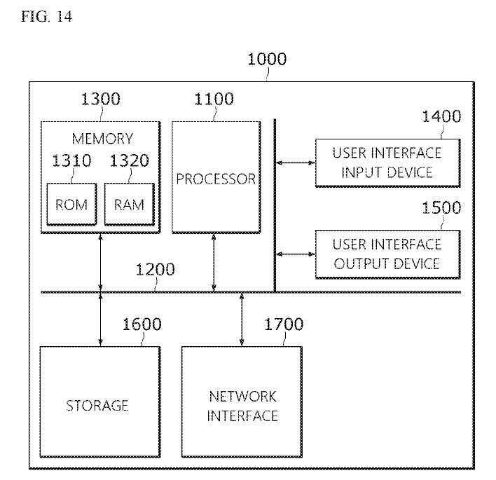

FIG. 14 shows an example computing system (e.g., a computing device of a vehicle or any other apparatus). One or more controllers, processors, etc. described herein, such as one or more components of the vehicle 10 and any other components and devices disclosed herein, may be implemented by or in the computing system as shown in FIG. 14.

A computing system 1000 may include at least one processor 1100, memory 1300, a user interface input device 1400, a user interface output device 1500, a storage 1600, and a network interface 1700, which are connected with each other via a bus 1200. The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

An autonomous vehicle control device according to an example of the present disclosure may comprise: a memory storing at least one instruction; and one or more processors connected to the memory, wherein the instruction is configured, when executed by the one or more processors, to cause the autonomous vehicle control device to: calculate a change value of a steering control amount by comparing a travel path of a vehicle at a first time point with a travel path of the vehicle at a second time point after the first time point; and when the change value is greater than or equal to a preset value, set any position in the travel path at the first time point as a start point, set any position in the travel path at the second time point as an end point, and generate a convergence path based on the start point and the end point.

In the control device according to some examples of the present disclosure, the instruction may be further configured to output the convergence path through an input/output interface of the vehicle, transmit the convergence path to another device through a communication unit of the vehicle, or control travel of the vehicle based on the convergence path.

In the control device according to some examples of the present disclosure, the start point may be set to a position at which a control target point of the vehicle at the first time point is positioned or a position on a reference line set with reference to a traveling direction of the vehicle at the first time point.

In the control device according to some examples of the present disclosure, the instruction may be further configured to calculate a lower limit value and an upper limit value of a longitudinal distance for setting an end point, based on a speed of the vehicle at the second time point and a regulatory allowable first lateral acceleration, and set the end point to a position between the lower limit value and the upper limit value.

In the control device according to some examples of the present disclosure, the instruction may be further configured to calculate a minimum radius of curvature of the vehicle based on a speed of the vehicle and the first lateral acceleration and set a longitudinal distance corresponding to the minimum radius of curvature as a lower limit of the end point.

In the control device according to some examples of the present disclosure, the instruction may be further configured to calculate a maximum radius of curvature of the vehicle based on a speed of the vehicle and a second lateral acceleration set to a value smaller than a regulatory allowable value and set a longitudinal distance corresponding to the maximum radius of curvature to an upper limit value of the end point.

In the control device according to some examples of the present disclosure, the instruction may be further configured to, according to a surrounding vehicle situation of the vehicle, select the end point as a point within a range that is greater than or equal to the lower limit value and less than or equal to the upper limit value.

In the control device according to some examples of the present disclosure, the surrounding vehicle situation may include at least one of whether there is another vehicle positioned in an adjacent lane of the vehicle or whether the preceding vehicle positioned in front in a traveling lane of the vehicle stops or decelerates.

In the control device according to some examples of the present disclosure, the instruction may be further configured to: set any position between the start point and the end point to an intermediate point; set a first sub-point between the start point and an intermediate point; set a second sub-point between the intermediate point and the end point; and generate the convergence path based on the start point, the intermediate point, the end point, the first sub-point, and the second sub-point.

In the control device according to some examples of the present disclosure, the instruction may be further configured to adjust positions of the first sub-point and the second sub-point based on a gain value calculated according to a speed of the vehicle, a distance between the start point and the end point, and a curvature difference between a lane on which the vehicle is traveling and a target lane.

A method of controlling an autonomous vehicle according to an example of the present disclosure may comprise: calculating a change value of a steering control amount by comparing a travel path of a vehicle at a first time point with a travel path of the vehicle at a second time point after the first time point; and when the change value is greater than or equal to a preset value, setting any position of the travel path at the first time point as a start point, setting any position of the travel path at the second time point as an end point, and generating a convergence path based on the start point and the end point.

In the method according to some examples of the present disclosure, the method may further comprise outputting the convergence path through an input/output interface of the vehicle, transmitting the convergence path to another device through a communication unit of the vehicle, or controlling travel of the vehicle based on the convergence path.

In the method according to some examples of the present disclosure, the start point may be set to a position at which a control target point of the vehicle at the first time point is located, or a point on a reference line set with reference to a traveling direction of the vehicle at the first time point.

In the method according to some examples of the present disclosure, a lower limit value and an upper limit value of a longitudinal distance for setting an end point may be calculated based on a speed of the vehicle and a regulatory allowable first lateral acceleration, and the end point may be set to a position between the lower limit value and the upper limit value.

In the method according to some examples of the present disclosure, a minimum radius of curvature of the vehicle may be calculated based on a speed of the vehicle and the first lateral acceleration, and a longitudinal distance corresponding to the minimum radius of curvature may be set as a lower limit value of the end point.

In the method according to some examples of the present disclosure, a maximum radius of curvature of the vehicle may be calculated based on a speed of the vehicle and a second lateral acceleration set to a value smaller than a regulatory allowable value, and a longitudinal distance corresponding to the maximum radius of curvature may be set as an upper limit value of the end point.

In the method according to some examples of the present disclosure, according to a surrounding vehicle situation of the vehicle, the end point may be selected as one of positions within a range of greater than or equal to the lower limit value and less than or equal to an upper limit value.

In the method according to some examples of the present disclosure, the surrounding vehicle situation may include at least one of whether there is another vehicle positioned in an adjacent lane of the vehicle or whether the preceding vehicle positioned in front in a traveling lane of the vehicle stops or decelerates.

In the method according to some examples of the present disclosure, any position between the start point and the end point may be set as an intermediate point; a first sub-point may be set between the start point and the intermediate point; a second sub-point may be set between the intermediate point and the end point; and a convergence path may be generated based on the start point, the intermediate point, the end point, the first sub-point, and the second sub-point.

In the method according to some examples of the present disclosure, positions of the first sub-point and the second sub-point may be adjusted based on a gain value calculated according to a speed of the vehicle, a distance between the start point and the end point, and a curvature difference between a lane on which the vehicle is traveling and a target lane.

According to an example of the present disclosure, a convergence path is generated in consideration of a traveling direction of a vehicle, a current speed, and a surrounding situation in a situation in which steering control amount suddenly changes, so that it is possible to mitigate a sudden change in the behavior of the vehicle and improve driving stability and ride comfort.

While the present disclosure has been described with reference to examples, it will be understood by those skilled in the art that various modifications and changes may be made thereto without departing from the spirit and scope of the disclosure as set forth in the claims that follow.

What is claimed is:

1. An apparatus of a vehicle, the apparatus comprising:
a processor; and
a memory storing at least one instruction that, when executed by the processor, is configured to cause the apparatus to:
determine a change value of a steering control amount associated with the vehicle by comparing a first travel path of the vehicle at a first time point with a second travel path of the vehicle at a second time point after the first time point,
based on the change value being greater than or equal a preset value:
set a first position in the first travel path at the first time point as a start point,
set a second position in the second travel path at the second time point as an end point,
generate, based on the start point and the end point, a convergence path,
output a signal indicating the convergence path, and
control, based on the signal, autonomous driving of the vehicle.

2. The apparatus of claim 1, wherein the at least one instruction, when executed by the processor, is configured to cause the apparatus to:
output the convergence path through an interface of the vehicle, and
transmit the convergence path to another vehicle through a communication interface of the vehicle.

3. The apparatus of claim 1, wherein the start point is set to one of:
a position at which a control target point of the vehicle at the first time point is positioned, or
a position on a reference line that is set based on a traveling direction of the vehicle at the first time point.

4. The apparatus of claim 1, wherein the at least one instruction, when executed by the processor, is configured to cause the apparatus to:
based on a speed of the vehicle at the second time point and a regulatory allowable first lateral acceleration, determine a lower limit value of a longitudinal distance and an upper limit value of the longitudinal distance, wherein the longitudinal distance corresponds to a forward distance along a traveling direction of the vehicle, and
set the end point to a position between the lower limit value and the upper limit value.

5. The apparatus of claim 4, wherein the at least one instruction, when executed by the processor, is configured to cause the apparatus to:
based on the speed of the vehicle and the regulatory allowable first lateral acceleration, determine a minimum feasible radius of curvature of a travel path of the vehicle, and
set a longitudinal distance corresponding to the minimum feasible radius of curvature as a lower limit of the end point.

6. The apparatus of claim 4, wherein the at least one instruction, when executed by the processor, is configured to cause the apparatus to:
based on the speed of the vehicle and a second lateral acceleration that is smaller than the regulatory allowable first lateral acceleration, determine a maximum feasible radius of curvature of a travel path of the vehicle, and
set a longitudinal distance corresponding to the maximum radius of curvature to an upper limit value of the end point.

7. The apparatus of claim 4, wherein the at least one instruction, when executed by the processor, is configured to cause the apparatus to, based on a surrounding environment of the vehicle, select the end point as a point between the lower limit value and the upper limit value.

8. The apparatus of claim 7, wherein the surrounding environment of the vehicle comprises at least one of:
whether another vehicle is positioned in an adjacent lane of the vehicle, or
whether another vehicle positioned in front of the vehicle in a traveling lane stops or decelerates.

9. The apparatus of claim 1, wherein the at least one instruction, when executed by the processor, is configured to cause the apparatus to:
set a position between the start point and the end point to an intermediate point,
set a first sub-point between the start point and the intermediate point,
set a second sub-point between the intermediate point and the end point, and
based on the start point, the first sub-point, the intermediate point, and the second sub-point, and the end point, generate the convergence path.

10. The apparatus of claim 9, wherein the the at least one instruction, when executed by the processor, is configured to cause the apparatus to adjust a position of the first sub-point and a position of the second sub-point based on:
a gain value determined based on a speed of the vehicle,
a distance between the start point and the end point, and
a curvature difference between a lane on which the vehicle is traveling and a target lane.

11. A method performed by an apparatus of a vehicle, the method comprising:
determining a change value of a steering control amount associated with the vehicle by comparing a first travel path of the vehicle at a first time point with a second travel path of the vehicle at a second time point after the first time point; and
based on the change value being greater than or equal to a preset value:
setting a first position in the first travel path at the first time point as a start point;
setting a second position in the second travel path at the second time point as an end point;
generating, based on the start point and the end point, a convergence path;
outputting a signal indicating the convergence path; and
controlling, based on the signal, autonomous driving of the vehicle.

12. The method of claim 11, further comprising:
outputting the convergence path through an interface of the vehicle; and
transmitting the convergence path to another vehicle through a communication interface of the vehicle.

13. The method of claim 11, wherein the start point is set to one of:
a position at which a control target point of the vehicle at the first time point is located, or
a point on a reference line that is set based on a traveling direction of the vehicle at the first time point.

14. The method of claim 11, further comprising:
based on a speed of the vehicle and a regulatory allowable first lateral acceleration, determining a lower limit value of a longitudinal distance and an upper limit value of the longitudinal distance, wherein the longitudinal distance corresponds to a forward distance along a traveling direction of the vehicle; and
setting the end point to a position between the lower limit value and the upper limit value.

15. The method of claim 14, further comprising:
based on the speed of the vehicle and the regulatory allowable first lateral acceleration, determining a minimum feasible radius of curvature of a travel path of the vehicle; and
setting a longitudinal distance corresponding to the minimum feasible radius of curvature as a lower limit value of the end point.

16. The method of claim 14, further comprising:
based on the speed of the vehicle and a second lateral acceleration that is smaller than the regulatory allowable first lateral acceleration, determining a maximum feasible radius of curvature of a travel path of the vehicle, and
setting a longitudinal distance corresponding to the maximum feasible radius of curvature as an upper limit value of the end point.

17. The method of claim 14, wherein the setting of the end point comprises selecting, based on a surrounding environment of the vehicle, one of positions between the lower limit value and the upper limit value to be the end point.

18. A vehicle comprising:
a sensor configured to obtain travel-path information associated with the vehicle; and
a processor circuit configured to cause the vehicle to:
obtain, via the sensor, first travel-path information at a first time and second travel-path information at a second time, and
based on a difference between the first travel-path information and the second travel-path information exceeding a threshold value:
set a start point at a position indicated in the first travel-path information,
set an end point at a position indicated in the second travel-path information,
wherein the end point is set between a lower limit value of a longitudinal distance and an upper limit value of the longitudinal distance, based on a speed of the vehicle and a lateral acceleration limit of the vehicle, and wherein the longitudinal distance corresponds to a forward distance along a traveling direction of the vehicle,
generate, based on the start point and the end point, a convergence path, wherein the convergence path is configured to connect a first trajectory represented by the first travel-path information to a second trajectory represented by the second travel-path information,
output a signal indicating the convergence path, and
control, based on the signal, autonomous driving of the vehicle.

19. The vehicle of claim 18, wherein the processor circuit is further configured to:
set a position between the start point and the end point as an intermediate point,
set a first sub-point between the start point and the intermediate point,
set a second sub-point between the intermediate point and the end point, and
generate the convergence path based on the start point, the first sub-point, the intermediate point, the second sub-point, and the end point.

20. The vehicle of claim 19, wherein the processor circuit is further configured to adjust positions of the first sub-point and the second sub-point based on:
a gain value determined based on the speed of the vehicle,
a distance between the start point and the end point, and
a curvature difference between a lane on which the vehicle is traveling and a target lane.
